(19) United States
(12) Patent Application Publication
(10) Pub. No.: US 2016/0189497 A1
(43) Pub. Date: Jun. 30, 2016

(54) SECURITY DEVICE FOR SECURING WEARABLE ELECTRONIC EQUIPMENT

(71) Applicant: Hangzhou Langhong Technology Co., Ltd., Zhejiang (CN)

(72) Inventors: Yuan Xin, Jiangsu (CN); Daqing Yang, Zhejiang (CN); Chenggang Yu, Zhejiang (CN)

(73) Assignee: Hangzhou Langhong Technology Co., Ltd., Zhejiang (CN)

(21) Appl. No.: 14/862,022

(22) Filed: Sep. 22, 2015

(30) Foreign Application Priority Data
Dec. 26, 2014 (CN) 201420849621.2

(51) Int. Cl. G08B 13/14

(52) U.S. Cl. CPC G08B 13/1463

(57) ABSTRACT

An anti-theft device for smart wearable gears display includes: a clamping device, a connection port and a thin sensor configured to connect with the clamping device and the product. The clamping device includes a top fixture and a bottom fixture, wherein the top and bottom fixtures are rotatably connected on one side and removably connected on the other side. A passage slot is formed between the inner facing surfaces of the top and bottom fixtures, which are used to accommodate a connection band of the displayed product. The bottom fixture includes a contact switch. The thin sensor and the contact switch are both electrically connected to the connection port, and the connection port is electrically connected to the controller.

### CROSS REFERENCE TO RELATED APPLICATIONS

This claims the priority to Chinese Application No. CN201420849621.2, filed on Dec. 26, 2014, the disclosure of which is incorporated by reference in its entirety.

### TECHNICAL FIELD

The present invention relates to anti-theft technology for digital product displays, and more particularly, to anti-theft devices for smart wearable gear displays that protect the smart wearable gears on display from theft.

### BACKGROUND

Generally, customers are inclined to have a personal experience with an interested electronic device before purchase. Thus, the sale of smart wearable gears has turned from enclosed displays to open displays.

However, current anti-theft devices cannot effectively protect the displayed products of smart wearable gears.

Chinese Patent No. CN203149749U, issued on 21 Oct., 2013, discloses a digital product display device with good anti-theft performance, which comprises a pedestal, a display stand arranged on the pedestal, and a supporting plate arranged on the display stand. The digital product display device also comprises a first contact switch, a second contact switch, a third contact switch used for detecting the battery status of a digital product, and a controller and an alarm arranged in the digital product display device. The first contact switch is arranged on the supporting plate. The second and third contact switches are arranged on the displayed digital product separately. The controller is electrically connected with the first, second and third contact switches, and the alarm separately. The shortcoming of the invention lies in its single functionality, which cannot provide sufficient protection to the displayed digital products.

### SUMMARY OF THE INVENTION

An object of this invention is to overcome the shortcoming of the existing anti-theft devices that cannot provide sufficient protection to the displayed smart wearable gears and to provide anti-theft devices for smart wearable gear displays that protect the smart wearable gears from theft.

In order to achieve this object, an embodiment of the invention is as the following:

An anti-theft device for wearable smart gear display, which is electrically connected to a controller (1) that is equipped with an alarm (2), comprising: a clamping device (3), a connection port (4) and a thin sensor (or thin sensor) (5) arranged on the clamping device (3), wherein the thin sensor (5) is configured for sticking on (or attaching to) a displayed product.

The clamping device (3) comprises a top fixture (6) and bottom fixture (7), wherein the top and bottom fixtures are rotatably connected on one side and removably connected on the other side. The top fixture (6) and bottom fixture (7) may be fixed together with a screw (17). A passage slot (8) is formed on the opposing inner surfaces of the top and bottom fixtures, which are used to contain and compress the connection band of the displayed product. The passage slot is preferably in a rectangular shape in cross section. The bottom fixture comprises a contact switch (9); the thin sensor (5) and the contact switch (9) are both electrically connected to the connector (connection port) (4), and the connection port (4) is electrically connected to the controller (1).

The clamping devices (3) are used to restrict the connection bands of the displayed products. The thin sensors (5) are used to monitor whether the displayed products are removed. The contact switches (9) are used to detect whether the connection bands are connected to the clamping devices (3). The alarms (2) are used to send alarm messages. The controllers (1) are used to detect the power levels (e.g., voltages) of the thin sensors (5) and the contact switches (9).

When a clamping device (3) is clamping on the connection band of a displayed product, the contact switch (9) in the clamping device (3) is closed. When the connection band is removed from the clamping device (3), the contact switch (9) is open.

The values of power levels (voltages) detected by the controller are different depending on whether the contact switch is open or closed.

By detecting the power levels at the two leads connected to the contact switch (9), the controller (1) can determine whether the connection band of the displayed product is removed. If the connection band is removed, the alarm (2) will sound under the control of the controller (1).

The thin sensor (5) is connected to the clamping device (3). When the connection between the thin sensor (5) and clamping device (3) is disrupted, the controller (1) will detect an abnormal electrical value on the thin sensor (5) and trigger the alarm (2) to sound.

When the connection between the controller and the anti-theft device is cut or damaged, or when the clamping device is damaged, or when the connection between the thin sensor and clamping device is cut or damaged, or when the thin sensor is cut or torn, the power levels (e.g., voltages) will change, and the controller will trigger the alarm to sound.

Therefore, embodiments of the invention can offer multiple layers of protection to ensure the safety of the displayed smart wearable gears. The devices of the invention are simple and easy to use.

Preferably, an anti-theft device of the invention further comprises a rectangular trough (indentation) (10) on the upper surface of the bottom fixture near the passage slot. Two elastic connectors (11) are set at the bottom of rectangular trough. A circuit board (16) fits into the rectangular trough. When the clamping device closes, the upper surface of the circuit board (16) contacts the top fixture, and two metal pads on the lower surface of the circuit board electrically contact the two conductive wires of the thin sensor, respectively. The two elastic connectors (11) are electrically connected to the connection port (4).

When the top and bottom fixtures are pressed tightly, the two elastic connectors (11) and the two metal pads on the lower side of the circuit board (16) are stably connected. When the top and bottom fixtures are separated, the two elastic connectors and the two metal pads are separated. Thus, the open or close conditions of a clamping device relate to the electrical connection between the thin sensor and the controller. By detecting the power levels, the controller can determine whether the thin sensor and the clamping device are connected or not.

Preferably, the top fixture of the clamping device may further include an indicator light (12), and the indicator light is electrically connected to controller via the connection port. The indicator light is used for the indication of working conditions. The light will be green when the device is working properly, and the light will be red when the alarm is triggered.

Preferably, the passage slot on the bottom fixture may include a gasket (13), and a window is provided on the gasket to expose the contact switch.

Preferably, the passage slot on the top fixture may include a gasket. The gasket can clamp on the displayed product connection band without damaging it.

Preferably, the connection port (4) may be arranged on the retaining bracket (14), which is electrically connected to a clamping device (3) via an electrical wire (15).

Therefore, embodiments of this invention may have one or more the following beneficial effects:
(1) Being capable of providing multiple layers of protection against theft to ensure safety of the displayed smart wearable products; and
(2) Being of simple structure and easy to use.

### BRIEF DESCRIPTION OF THE DRAWINGS

FIG. 1 shows a structure diagram of an embodiment of this invention.

FIG. 2 shows another structure diagram of an embodiment of this invention.

FIG. 3 shows a structure diagram wherein a thin sensor and the elastic connectors are disconnected in accordance with one embodiment of the invention.

FIG. 4 shows a structure diagram wherein a thin sensor and the elastic connectors are connected in accordance with one embodiment of the invention.

FIG. 5 shows an explanatory block diagram indicating a principle structure in accordance with one embodiment of the invention.

Legend: controller (1), alarm (2), clamping device (3), connection port (4), thin (plate) sensor (5), top fixture (6), bottom fixture (7), passage slot (8), contact switch (9), rectangular trough (10), elastic connectors (11), indicator light (12, gasket (13), retaining bracket (14), electrical wire (15), circuit board (16), screw (17).

### DETAILED DESCRIPTION OF THE INVENTION

A detailed description of this invention is made with reference to the figures and examples of this invention.

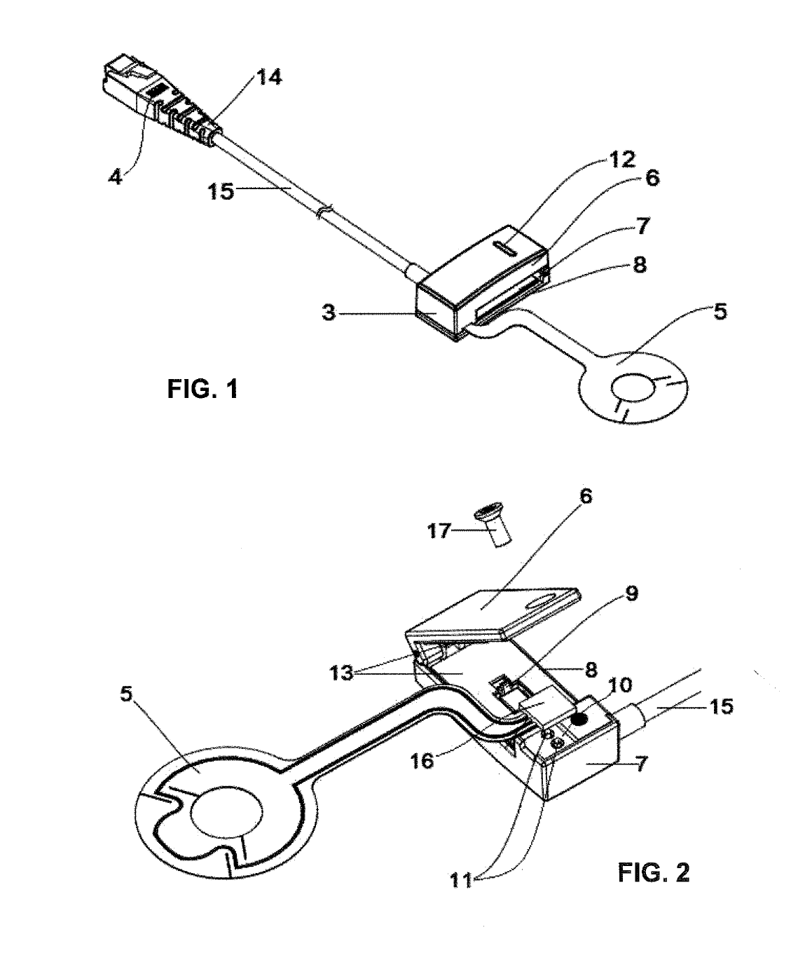

FIG. 1 and FIG. 2 show a diagram of an anti-theft device for wearable smart gear display. An anti-theft device of the invention is electrically connected with a controller (1) that is equipped with an alarm (2). The anti-theft device comprises: a clamping device (3), a connection port (4) and a flexible printed circuit (FPC) thin sensor (5) (also referred to as a “thin sensor”), which is configured to be connected with the clamping device and to be attached to (stuck to) a displayed product.

A clamping device comprises a top fixture (6) and a bottom fixture (7), wherein the top and bottom fixture are rotatably connected on one side and removably connected on the other side. A passage slot (8) is provided in the opposite inner surfaces of the top and bottom fixture. The passage slot is used to accommodate and/or compress a connection band (or connection ribbon) of a displayed product. The bottom fixture comprises a contact switch (9). The FPC thin sensor and the contact switch are both electrically connected to a connection port, and the connection port is electrically connected to a controller.

As shown in FIG. 2, an anti-theft device for wearable smart gear display may further comprise a rectangular trough (indentation) (10) on an upper surface of the bottom fixture near the passage slot. Two elastic/flexible connectors (11) are set at the bottom of rectangular trough. A circuit board (16) fits into the rectangular trough.

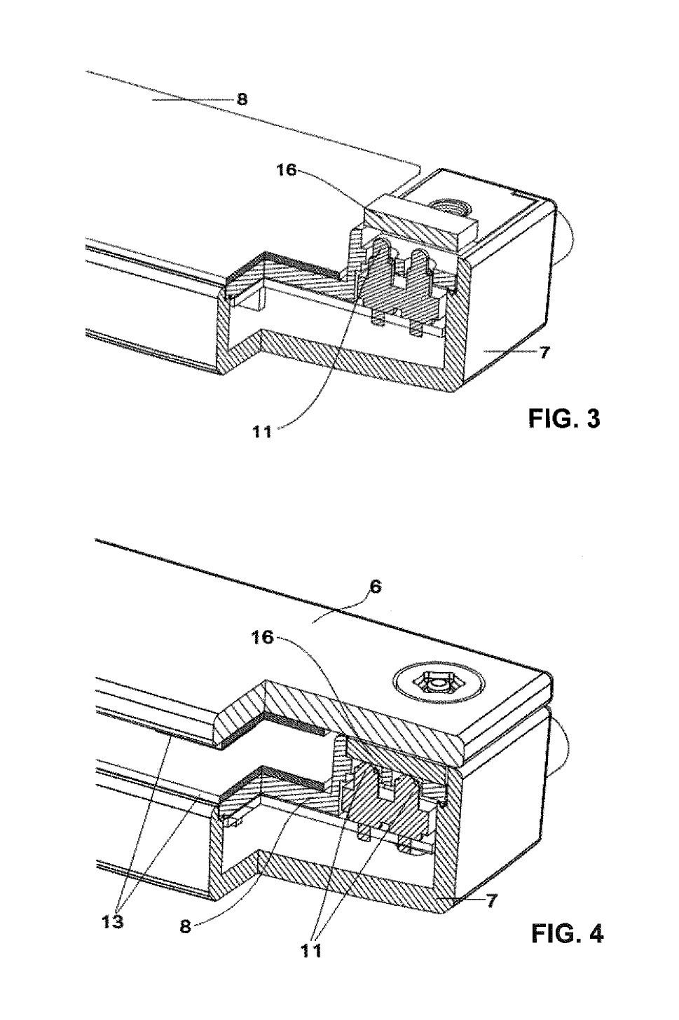

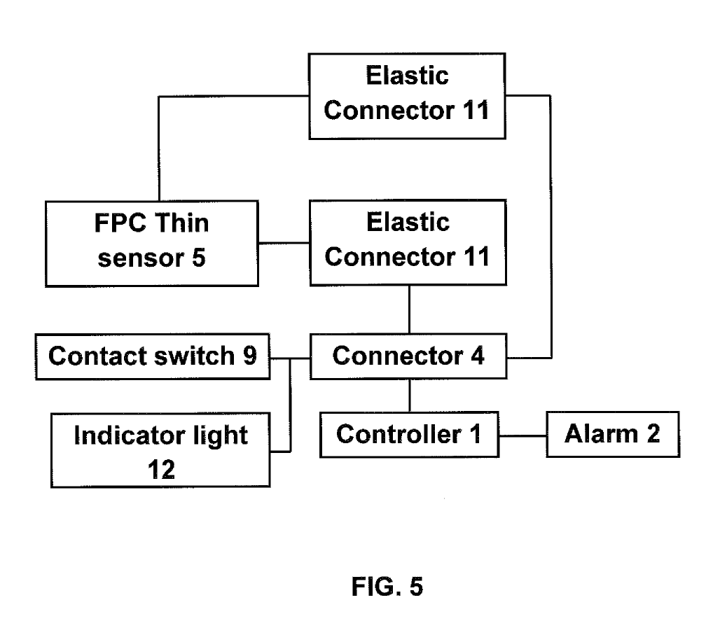

As shown in FIG. 3 and FIG. 4, when the top and bottom fixtures close up, the upper surface of the circuit board touches the top fixture. As shown in FIG. 5, two metal pads on the lower surface of circuit board electrically contact the two conductive wire of the FPC thin sensor, respectively. The two elastic connectors are electrically connected to the connection port.

As shown in FIG. 2, the top fixture may further include an indicator light (12), and the indicator light is electrically connected to the connection port. The passage slot on the bottom fixture may include a gasket (13), and a window is provided on the gasket to expose the contact switch. The passage slot on the top fixture may also include a gasket (13). The connection port may be arranged on a retaining bracket (14), and the retaining bracket is electrically connected to the clamping device via electrical wires (15).

An exemplary working process of this invention is as follows:

When the top fixture is opened, a band of a displayed smart watch can be put into the passage slot. Then, the top fixture is closed, as illustrated in FIG. 2 using a screw (17) to screw the bottom and top fixtures together. As shown in FIG. 4, a FPC thin a sensor is electrically connected to the connection port via two metal pads and two elastic/flexible connectors, and the contact switch of the bottom fixture is pressed.

The FPC thin sensor may be attached on the back of a watch case, and the controller will test the power levels (e.g., voltage) of the two pins connected to the FPC thin sensor. The controller will also test the power levels of the two pins connected to the contact switch at the same time.

When the electrical connections of the anti-theft device and the controller is broken or destroyed, or the clamping device is broken, or the connection of FPC thin sensor and clamping device is off or destroyed, or the FPC thin sensor is cut or destroyed, under all these situations, the power levels will change, and the controller may trigger the alarm to sound.

It should be understood that the above-described embodiment are only for illustration of the invention and are not intended as limitations of the scope of the invention. One skilled in the art would appreciate that variations and modifications are possible without departing from the scope of the invention, which should be defined by the attached claims. Such modifications and variation forms are intended to be within the scope of the claims.

What is claimed is:

1. An anti-theft device for displaying a product, which is configured to be electrically connected with a controller that includes an alarm, comprising:
a clamping device;
a connection port; and
a thin sensor configured to be attached to the clamping device and to the product,
wherein the clamping device comprises: a top fixture and a bottom fixture, wherein the top and bottom fixtures are rotatably connected on one side and removably connected on the other side; wherein a passage slot is formed on inner surfaces of the top and bottom fixtures, wherein the passage slot is configured to accommodate a connection band of the product, wherein the bottom fixture comprises a contact switch, wherein the thin sensor and the contact switch are electrically connected to the connection port, and the connection port is electrically connected to the controller.

2. The anti-theft device of claim 1, further comprising:
a rectangular trough on an upper surface of the bottom fixture near the passage slot;
two elastic connectors arranged at the bottom of the rectangular groove; and
a circuit board configured to fit into the rectangular trough;
wherein when the bottom and top fixtures close up, an upper surface of the circuit board contacts the top fixture, and two metal pads on a lower surface of the circuit board electrically connect with two conductive wires of the thin sensor, respectively, and
wherein the two elastic connectors are electrically connected to the connection port.

3. The anti-theft device of claim 1, wherein the top fixtures further comprises an indicator light, wherein the indicator light is electrically connected to the connection port.

4. The anti-theft device of claim 1, wherein the passage slot on the bottom fixture comprises a gasket, and a window is provided on the gasket to allow the contact switch to be exposed.

5. The anti-theft device of claim 1, wherein the passage slot on the top fixture comprise a second gasket.

6. The anti-theft device of claim 1, wherein the connection port is disposed on a retaining bracket, and the retaining bracket is electrically connected to the clamping device via an electrical wire.

7. The anti-theft device of claim 2, wherein the connection port is disposed a retaining bracket, and the retaining bracket is electrically connected to the clamping device via an electrical wire.

8. The anti-theft device of claim 3, wherein the connection port is disposed a retaining bracket, and the retaining bracket is electrically connected to the clamping device via an electrical wire.

9. The anti-theft device of claim 4, wherein the connection port is disposed a retaining bracket, and the retaining bracket is electrically connected to the clamping device via an electrical wire.

10. The anti-theft device of claim 5, wherein the connection port is disposed a retaining bracket, and the retaining bracket is electrically connected to the clamping device via an electrical wire.
